(19) United States
(12) Patent Application Publication
(10) Pub. No.: US 2026/0053138 A1
(43) Pub. Date: Feb. 26, 2026

(54) TRINEXAPAC-ETHYL FORMULATIONS

(71) Applicant: ADAMA AUSTRALIA PTY LIMITED, New South Wales (AU)

(72) Inventors: Andrew HORSFIELD, St Leonards, New South Wales (AU); Peter VAUGHAN, Caboolture, Queensland (AU)

(21) Appl. No.: 19/104,698

(22) PCT Filed: Aug. 22, 2023
(86) PCT No.: PCT/AU2023/050798

§ 371 Date: Feb. 18, 2025

(30) Foreign Application Priority Data
Aug. 19, 2022 (AU) 2022902376

(51) Int. Cl. A01N 37/42; A01N 25/04; A01N 25/30; A01P 21/00

(52) U.S. Cl. CPC A01N 37/42; A01N 25/04; A01N 25/30; A01P 21/00

(57) ABSTRACT

A novel formulation of trinexapac-ethyl is described. The formulation can be applied at higher concentrations and form a stable emulsion or lower concentrations and form a stable micro-emulsion. The formulation has greater than 400 grams of active ingredient per liter. The formulation can be applied in all situations where trinexapac-ethyl is used.

### TECHNICAL FIELD

The invention relates to novel formulations containing trinexapac-ethyl that is preferably used as either a microemulsion or emulsifiable concentrate in agriculture and non-crop areas for regulating the growth of plants.

### BACKGROUND ART

Trinexapac-ethyl has the following structural Formula (1):

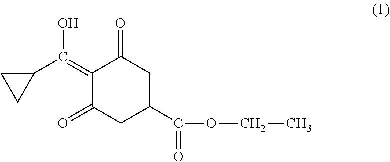 [SMILES: CCOC(=O)C1CC(=O)C(=C(O)C2CC2)C(=O)C1]

Trinexapac-ethyl is a cyclohexanedione derivative and is used as a plant growth regulator/retardant, chemical ripener and harvest aid. Key uses include prevention of lodging in cereals, pulses and oilseed rape, growth inhibition in turf to reduce mowing, reducing vegetative growth to increase seed production in ryegrass seed crops, modifying the alkaloid ratio in poppies and increasing the sugar content of sugar cane. Trinexapac-ethyl's mode of action it to inhibit 3β-hydroxylation of GA20 to GA3 in gibberellin biosynthesis. The reduced level of gibberellins leads to reduced growth in plants.

Trinexapac-ethyl was first reported by E. Kerber (Proc. Br. Crop Protection Conf., 1989, 1, 83). The chemical name of trinexapac-ethyl is ethyl 4-cyclopropyl(hydroxy)methylene-3,5-dioxocyclohexanecarboxylate. It is available in the marketplace as liquid formulations such as microemulsion concentrates (ME), emulsifiable concentrates (EC), dispersible concentrates (DC), soluble liquids (SL) and solid formulations such as wettable powders.

Depending on the situation, certain formulation types are preferred due to risk of phytotoxicity and/or where enhanced activity is required and adjuvants or surfactants are included as co-formulants. In turf grass management such as golf greens, ME or SL formulations are often preferred due to the reduced risk of phytotoxicity. In other situations, such as golf fairways and agricultural uses in cereals, pulses, canola, poppies, ryegrass seed production, sugarcane and poppies, formulations such as DC or EC are widely used. Typical active ingredient concentrations of commercial trinexapac-ethyl solo formulations range from 120 g ai/L in ME formulations to 175 to 250 g ai/L in EC and DC formulations.

Standard ME formulations can contain very high concentrations of solvents, surfactants and emulsifiers. In use, these ME formulations are often diluted in a high volume of water and the stability of the micro-emulsion is critical to avoid formation of sediment after mixing and prior to or during application. Trinexapac-ethyl technical has a typical pH range of 3 to 5. Depending on the solvents, surfactants and emulsifiers selected to create a stable formulation, the pH of commercial formulations can be as low as pH 2 when diluted at 1% in water. While lower pH can improve the efficacy of trinexapac-ethyl when applied to crops such as wheat, low pH formulations, i.e. <pH 3.0, can present a risk for operator safety during mixing and application.

ME formulations with a higher concentration of active ingredient i.e. 200 to 400 g ai/L; have also been disclosed in prior art including WO2021239591. Formulations described in WO2021239591 are based on polyethylene oxide and polypropylene oxide block copolymers to achieve adequate shelf life. Additional emulsifiers are required such as castor oil ethoxylates. These formulations also contain 400 to 600 g/L of water-miscible solvent.

### SUMMARY OF THE INVENTION

In the first aspect, the invention provides a stable trinexapac-ethyl formulation comprising:
trinexapac-ethyl at a concentration greater than 400 g ai/L;
a suitable primary emulsifier; and
a total solvent concentration of less than 400 g/L

The concentration of trinexapac-ethyl may be considerably more than 400 g ai/L. In one embodiment, the concentration is more than 600 g ai/L.

Preferably, the suitable primary emulsifier is an ethoxylated tristyrylphenol, but the primary emulsifier is not limited to this. The primary emulsifier may also act as a surfactant. The formulation of the invention may contain a secondary emulsifier. The formulation of the invention may contain one or more surfactants. In one embodiment, the formulation contains an additional emulsifier or surfactant that is a linear calcium dodecylbenzene sulphonate.

The formulation of the invention may contain one or more solvents. Non-limiting examples are benzyl alcohol and caprylic-capric methyl ester.

The formulation of the invention is preferably an emulsifiable concentrate or a micro-emulsion, but may take other forms, including oil dispersion, oil in water emulsion, oil miscible liquid, suspo-emulsion or a mixed formulation such as a capsule suspension and suspo-emulsion or capsule suspension and emulsion in water.

The stability of formulations used in both agricultural and non-crop situations is critical to ensure long term shelf life i.e. a minimum of two years, demonstrated under accelerated testing conditions. Formulations according to this invention are stable.

Embodiments of this invention can enable formulations that demonstrate each of EC and ME properties, depending on the dilution rate. For example, if the formulation of the invention is a concentrated emulsion, the embodiment can form a stable emulsion when diluted at a concentration of at least 5 grams of active ingredient per litre of water. In another embodiment, the formulation of the invention can form a microemulsion when diluted at a concentration of 1 gram of active ingredient per litre of water.

Preferably, the formulation of the invention has a pH of 3 or more when diluted with water.

The formulation of the invention may be used as a plant growth regulator/retardant, chemical ripener, alkaloid ratio modifier or harvest aid.

Formulations of this invention can be applied as a microemulsion in situations where ME or SL formulations are preferred such as golf greens.

When applied in turf grass situations, formulations of this invention may provide similar or superior reduction in growth and improved turf quality, compared with prior art formulations.

Formulations of this invention may be applied as a conventional emulsion or micro-emulsion when applied at typical use rates in cereals, pulses, canola, sugarcane, poppies, rice.

Formulations of the invention may be used as a tank mix, in a co-formulation or as part of a sequence of applications. A systemic acquired resistance compound, a fertilizer and/or other plant nutritional preparation may be used with the formulation of the invention. The formulation of the invention may contain or be used with any of an adjuvant, surfactant, penetrant, spreader or wetter for use either in a tank mixture or as a co-formulant.

In some embodiments, the formulation is applied as an emulsifiable concentrate in water volumes of 200 L/ha or less. In some embodiments, the formulation is applied at an active ingredient rate greater than 100 g ai/ha, in water volumes of greater than 200 L/ha.

### DETAILED DESCRIPTION OF PREFERRED EMBODIMENTS

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

The term “a” or “an” as used herein includes the singular and the plural, unless specifically stated otherwise. Therefore, the terms “a,” “an” or “at least one” can be used interchangeably in this application.

As used herein, the term “stable” in relation to a formulation means that the formulation has a long-term shelf life i.e. a minimum of two years, demonstrated under accelerated testing conditions.

Throughout the application, descriptions of various embodiments use the term “comprising”; however, it will be understood by one of skill in the art, that in some specific instances, an embodiment can alternatively be described using the language “consisting essentially of’ or “consisting of.”

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

Reference will now be made in detail to certain embodiments of the invention. While the invention will be described in conjunction with the embodiments and/or examples, it will be understood that the intention is not to limit the invention to those embodiments/examples. On the contrary, the invention is intended to cover all alternatives, modifications, and equivalents, which may be included within the scope of the present invention.

One skilled in the art will recognize many methods and materials similar or equivalent to those described herein, which could be used in the practice of the present invention. The present invention is in no way limited to the methods and materials described.

### Example 1

Trinexapac-ethyl 625 g/L emulsifiable concentrate (EC) or micro-emulsion (ME). Development code is AD-AU-2116.

The components are set out in Table 1:

TABLE 1
Components

| Content | | Purpose in | |
|---|---|---|---|
| g/L | Component | Formulation | Supplier |
| 641.68 | Trinexapac-ethyl | active | Jiangsu Huifeng Bio |
| | Technical 97.4% | ingredient | Agriculture |
| 35.04 | Trisol 460 | Emulsifier/ | TriTech Chemical |
| | | surfactant | Company Pty Ltd |
| 81.76 | Termul 3150 | emulsifier/ | Indorama Ventures Oxides |
| | | surfactant | Pty Ltd |
| 147.02 | Benzyl alcohol | solvent | DKSH Performance |
| | | | Materials Australia |
| | | | Pty Ltd |
| 198.36 | Stepan C-25 | solvent | Stepan Company |

Details of the components are set out in Table 2:

TABLE 2
Component Details

| Trade Name | IUPAC NAME | CAS # |
|---|---|---|
| Trinexapac-ethyl | ethyl 4- | 95266-40-3 |
| Technical 97.4% | cyclopropyl(hydroxy)methylene-3,5- | |
| | dioxocyclohexanecarboxylate | |
| Trisol 460 | linear dodecylbenzene sulphonate, | 26264-06-2 |
| | calcium salt in solvent 2-ethylhexanol | 104-76-7 |
| Termul 3150 | tristyrylphenol ethoxylate | 99734-09-5 |
| Benzyl alcohol | phenyl methanol | 100-51-6 |
| Stepan C-25 | Caprylic-capric methyl ester (C8 60%, | 68937-83-7 |
| | C10 37%) | |

To prepare the formulation, melt the required amount of trinexapac-ethyl tech prior to formulation and maintain it in a completely molten state prior to addition.

Charge the Benzyl Alcohol into a suitable stainless-steel mixing vessel equipped with a propeller type stirrer, commence mixing and add the Stepan C-25.

Continue mixing and add the Termul 3150.

Continue mixing and add the Trisol 460.

Continue mixing and add the molten trinexapac-ethyl technical.

Continue mixing for further 15 min. Ensure the product is completely homogeneous.

TABLE 3
Analysis

| Determination | Method | Specification | Analysis | Result |
|---|---|---|---|---|
| Appearance, | Visual | Clear amber | Clear amber | PASS |
| Physical | | liquid | liquid | |
| State & | | | | |
| Colour | | | | |
| Odour | Olfactory | Slight rancid | Slight rancid | PASS |
| | | odour | odour | |
| pH - 1% v/v | CIPAC MT | 2.80-3.80 | 3.20 | PASS |
| dilution | 75.3 | | | |
| Density @ | Density | 1.095-1.111 | 1.101 g/mL | PASS |
| 20° C. | Meter Anton | g/mL | | |
| | Paar DMA 48 | | | |
| Water Karl | CIPAC MT | <0.30% | 0.20% | PASS |
| Fisher | 30.5 | | | |
| Emulsion | CIPAC MT | Initial | Initial | PASS |
| characteristics | 36.3 | emulsification | emulsification | |
| CIPAC Std | 160 μL/100 | uniform | uniform | |
| Water A | mL | 30 min < 0.05 mL | 30 min < 0.05 mL | |
| | | cream, trace oil | cream, no oil | |
| | | 2 h < 0.05 mL | 2 h < 0.05 mL | |
| | | cream, trace oil | cream, no oil | |
| | | 24 h re- | 24 h re- | |
| | | emulsification | emulsification | |
| | | complete | complete | |
| | | 24.5 h < 0.05 mL | 24.5 h < 0.05 mL | |
| | | cream, trace oil | cream, no oil | |
| Emulsion | | Initial | Initial | PASS |
| characteristics | | emulsification | emulsification | |
| CIPAC Std | | uniform | uniform | |
| Water E | | 30 min < 0.05 mL | 30 min < 0.05 mL | |
| | | cream, trace oil | cream, no oil | |
| | | 2 h < 0.05 mL | 2 h < 0.05 mL | |
| | | cream, trace oil | cream, no oil | |
| | | 24 h re- | 24 h re- | |
| | | emulsification | emulsification | |
| | | complete | complete | |
| | | 24.5 h < 0.05 mL | 24.5 h < 0.05 mL | |
| | | cream, trace oil | cream, no oil | |
| Emulsion | CIPAC MT | Initial | Initial | PASS |
| characteristics | 36.3 | emulsification | emulsification | |
| CIPAC Std | 800 μL / 100 | uniform | uniform | |
| Water A | mL | 30 min < 0.05 mL | 30 min < 0.05 mL | |
| | | cream, trace oil | cream, no oil | |
| | | 2 h < 0.05 mL | 2 h < 0.05 mL | |
| | | cream, trace oil | cream, no oil | |
| | | 24 h re- | 24 h re- | |
| | | emulsification | emulsification | |
| | | complete | complete | |
| | | 24.5 h < 0.05 mL | 24.5 h < 0.05 mL | |
| | | cream, trace oil | cream, no oil | |
| Emulsion | | Initial | Initial | PASS |
| characteristics | | emulsification | emulsification | |
| CIPAC Std | | uniform | uniform | |
| Water E | | 30 min < 0.05 mL | 30 min < 0.05 mL | |
| | | cream, trace oil | cream, no oil | |
| | | 2 h < 0.05 mL | 2 h < 0.05 mL | |
| | | cream, trace oil | cream, no oil | |
| | | 24 h re- | 24 h re- | |
| | | emulsification | emulsification | |
| | | complete | complete | |
| | | 24.5 h < 0.05 mL | 24.5 h < 0.05 mL | |
| | | cream, trace oil | cream, no oil | |
| Persistent foam | CIPAC MT | max 60 mL foam | After 1 min: | PASS |
| Standard Water | 47.2 | after 1 min | 21 mL | |
| C | 1.6 mL/200 | | | |
| | mL | | | |
| Content | QCM-123.02 | 600 to 650 g/L | 633 g/L | PASS |
| Trinexapac-ethyl | | | | |

The formulation was suitable for packaging in a COEX HDPE container with a screw cap closure.

The formulation was subjected to accelerated storage conditions in that HDPE container. It was determined to be stable to heat for 2 weeks at 54° C. and therefore is expected to be shelf stable for at least 2 years.

A 100 mL sample of the formulation which has been subjected to accelerated storage conditions as above was then moved to a centrifuge tube and subjected to seeded cold storage conditions for 7 days at 0° C. The absence of any separated material indicated that the formulation was cold storage stable.

The formulation is stable for all parameters according to the standard CIPAC accelerated testing regime of 14 days at 54° C.

The formulation was also tested for physical compatibility with a range of crop protection products, adjuvants and fertilisers.

TABLE 4
Compatibility of AD-AU-2116

| AD-AU-2116 | Spray | | | | |
|---|---|---|---|---|---|
| rate | volume | Product | Rate | | Result |
| 160 mL/ha | 50 L/ha | Priority + LVE MCPA | 25 mL/ha + 440 | | COMPATIBLE |
| | | 570 + Uptake | mL/ha + 0.5% v/v | | |
| 160 mL/ha | 50 L/ha | Flagship 400 | 500 | mL/ha | COMPATIBLE |
| 160 mL/ha | 50 L/ha | Inego + Adigor | 300 mL/ha + 0.5% | | COMPATIBLE |
| | | | v/v | | |
| 160 mL/ha | 50 L/ha | Mandate Xtra + | 160 mL/ha + 1.0% | | COMPATIBLE |
| | | Hasten | v/v | | |
| 160 mL/ha | 50 L/ha | Proviso | 250 | mL/ha | COMPATIBLE |
| 160 mL/ha | 50 L/ha | Velocity + LVE | 670 mL/ha + 400 | | COMPATIBLE |
| | | MCPA 570 + Hasten | mL/ha + 1.0% v/v | | |
| 160 mL/ha | 50 L/ha | Kinetic adjuvant | 1.0% | v/v | COMPATIBLE |
| 160 mL/ha | 50 L/ha | Radial Opti | 250 | mL/ha | COMPATIBLE |
| 160 mL/ha | 50 L/ha | Maxentis EC | 600 | mL/ha | COMPATIBLE |
| 160 mL/ha | 50 L/ha | Alpha-Scud 300 | 40 | mL/ha | COMPATIBLE |
| 160 mL/ha | 50 L/ha | Aphidex 800 | 190 | g/ha | COMPATIBLE |
| 160 mL/ha | 50 L/ha | Paradigm + LVE | 25 g/ha + 630 | | COMPATIBLE |
| | | MCPA 570 + Hasten | mL/ha + 1.0% v/v | | |
| 160 mL/ha | 50 L/ha | Pyrinex Super | 1.0 | L/ha | COMPATIBLE |
| 160 mL/ha | 50 L/ha | Victory 600 | 150 | mL/ha | COMPATIBLE |
| 160 mL/ha | 50 L/ha | Picoflex + MCPA 750 | 110 mL/ha + 560 | | COMPATIBLE |
| | | | mL/ha | | |
| 160 mL/ha | 80 L/ha | Flexi N | 50 | L/ha | COMPATIBLE |

In conclusion, the novel trinexapac-ethyl formulation enables a stable concentration of >400 g ai/L with desirable emulsion stability properties over a range of concentrations and water quality. The formulation detailed above is compatible with a wide range of crop protection products, adjuvants and fertilisers.

### EXPERIMENTAL DETAILS

### Example 2

In this example, two field trials was conducted in 2022 at Clergate, New South Wales, Australia in couch grass cv. Santa Ana, and kikuyu. Marvel, Marvel Ultra and AD-AU-2116 were applied at similar rates using a hand boom in a spray volume of 430 L/ha (Table 5 and Table 6).

Dry clipping yield weights, NDVI (Normalised Difference Vegetation Index) and phytotoxicity were assessed 0, 14, 28 and 42 days after application.

TABLE 5
Treatment details applied to evaluate
AD-AU-2116 in couch turfgrass.

| | | Active | Product | |
|---|---|---|---|---|
| S. | Product | ingredient and | rate | Dose rate |
| No. | (Test compounds) | concentration | (mL/ha) | (g ai/ha) |
| 1 | Untreated | — | — | — |
| 2 | MARVEL | Trinexapac-ethyl | 700 | 122.5 |
| | | 175 EC | | |
| 3 | MARVEL | Trinexapac-ethyl | 1400 | 245 |
| | | 175 EC | | |
| 4 | MARVEL | Trinexapac-ethyl | 2750 | 481 |
| | | 175 EC | | |
| 5 | MARVEL | Trinexapac-ethyl | 5500 | 963 |
| | | 175 EC | | |
| 6 | MARVEL ULTRA | Trinexapac-ethyl | 1000 | 120 |
| | | 120 ME | | |
| 7 | MARVEL ULTRA | Trinexapac-ethyl | 2000 | 240 |
| | | 120 ME | | |
| 8 | MARVEL ULTRA | Trinexapac-ethyl | 4000 | 480 |
| | | 120 ME | | |
| 9 | MARVEL ULTRA | Trinexapac-ethyl | 8000 | 960 |
| | | 120 ME | | |
| 10 | AD-AU-2116 | Trinexapac-ethyl | 200 | 125 |
| | | 625 EC/ME | | |
| 11 | AD-AU-2116 | Trinexapac-ethyl | 400 | 250 |
| | | 625 EC/ME | | |
| 12 | AD-AU-2116 | Trinexapac-ethyl | 800 | 500 |
| | | 625 EC/ME | | |
| 13 | AD-AU-2116 | Trinexapac-ethyl | 1600 | 1000 |
| | | 625 EC/ME | | |

TABLE 6
Treatment details applied to evaluate
AD-AU-2116 in kikuyu turfgrass.

| | Product | Active | Product | |
|---|---|---|---|---|
| S. | (Test | ingredient and | rate | Dose rate |
| No. | compounds) | concentration | (mL/ha) | (g ai/ha) |
| 1 | Untreated | — | — | — |
| 2 | MARVEL | Trinexapac-ethyl | 1400 | 245 |
| | | 175 EC | | |
| 3 | MARVEL | Trinexapac-ethyl | 2750 | 481 |
| | | 175 EC | | |
| 4 | MARVEL | Trinexapac-ethyl | 5500 | 963 |
| | | 175 EC | | |
| 5 | MARVEL | Trinexapac-ethyl | 11000 | 1925 |
| | | 175 EC | | |
| 6 | MARVEL ULTRA | Trinexapac-ethyl | 2000 | 240 |
| | | 120 ME | | |
| 7 | MARVEL ULTRA | Trinexapac-ethyl | 4000 | 480 |
| | | 120 ME | | |
| 8 | MARVEL ULTRA | Trinexapac-ethyl | 8000 | 960 |
| | | 120 ME | | |
| 9 | MARVEL ULTRA | Trinexapac-ethyl | 16000 | 1920 |
| | | 120 ME | | |
| 10 | AD-AU-2116 | Trinexapac-ethyl | 400 | 250 |
| | | 625 EC/ME | | |
| 11 | AD-AU-2116 | Trinexapac-ethyl | 800 | 500 |
| | | 625 EC/ME | | |
| 12 | AD-AU-2116 | Trinexapac-ethyl | 1600 | 1000 |
| | | 625 EC/ME | | |
| 13 | AD-AU-2116 | Trinexapac-ethyl | 3200 | 2000 |
| | | 625 EC/ME | | |

TABLE 7
Reduction in clipping yields and NDVI in couch
turfgrass 42 days after application.

| | | Product | | | |
|---|---|---|---|---|---|
| S. | Product | rate | % change in dry | | |
| No. | (Test compounds) | (mL/ha) | clipping weights | | NDVI |
| 1 | Untreated | — | 5.61 | d | 0.71 c |
| 2 | MARVEL | 700 | −5.90 | c | 0.74 abc |
| 3 | MARVEL | 1400 | −7.77 | abc | 0.73 bc |
| 4 | MARVEL | 2750 | −9.08 | abc | 0.74 abc |
| 5 | MARVEL | 5500 | −8.30 | abc | 0.76 ab |
| 6 | MARVEL ULTRA | 1000 | −6.11 | bc | 0.75 ab |
| 7 | MARVEL ULTRA | 2000 | −8.30 | abc | 0.73 bc |
| 8 | MARVEL ULTRA | 4000 | −9.49 | abc | 0.76 ab |
| 9 | MARVEL ULTRA | 8000 | −8.59 | abc | 0.75 ab |
| 10 | AD-AU-2116 | 200 | −7.31 | abc | 0.74 abc |
| 11 | AD-AU-2116 | 400 | −8.19 | abc | 0.76 ab |
| 12 | AD-AU-2116 | 800 | −9.92 | ab | 0.77 a |
| 13 | AD-AU-2116 | 1600 | −10.13 | a | 0.76 ab |

Means within each column followed by the same letter are not significantly different (LSD P=0.05)

TABLE 8
Reduction in clipping yields and NDVI in kikuyu
turfgrass 42 days after application.

| | | Product | | | |
|---|---|---|---|---|---|
| S. | Product | rate | % change in dry | | |
| No. | (Test compounds) | (mL/ha) | clipping weights | | NDVI |
| 1 | Untreated | — | 2.81 | e | 0.67 bc |
| 2 | MARVEL | 700 | −10.60 | bcd | 0.66 c |
| 3 | MARVEL | 1400 | −9.13 | cd | 0.66 c |
| 4 | MARVEL | 2750 | −14.14 | ab | 0.68 abc |
| 5 | MARVEL | 5500 | −11.72 | bcd | 0.68 abc |
| 6 | MARVEL ULTRA | 1000 | −7.73 | d | 0.68 abc |
| 7 | MARVEL ULTRA | 2000 | −12.67 | bc | 0.66 c |
| 8 | MARVEL ULTRA | 4000 | −12.16 | bcd | 0.68 abc |
| 9 | MARVEL ULTRA | 8000 | −14.06 | ab | 0.68 abc |
| 10 | AD-AU-2116 | 200 | −13.77 | ab | 0.69 abc |
| 11 | AD-AU-2116 | 400 | −14.17 | ab | 0.72 a |
| 12 | AD-AU-2116 | 800 | −15.21 | ab | 0.72 a |
| 13 | AD-AU-2116 | 1600 | −18.11 | a | 0.71 ab |

Means within each column followed by the same letter are not significantly different (LSD P=0.05)

The results established that:
AD-AU-2116 provided a similar reduction in dry clipping yield and a similar or better improvement in NDVI in couch when compared to both MARVEL and MARVEL ULTRA,
AD-AU-2116 provided a similar reduction or better in dry clipping yield and a similar or better improvement in NDVI in kikuyu when compared to both MARVEL and MARVEL ULTRA.

### INDUSTRIAL APPLICABILITY

The novel trinexapac-ethyl formulation of the invention enables a stable concentration of >400 g ai/L with desirable emulsion stability properties over a range of concentrations and water quality. The formulation of the invention may be compatible with a wide range of crop protection products, adjuvants and fertilisers and its performance is comparable or superior to known formulations of lower concentrations.

1. A stable trinexapac-ethyl formulation comprising:
trinexapac-ethyl at a concentration greater than 400 g ai/L;
a suitable primary emulsifier; and
a total solvent concentration of less than 400 g/L

2. The trinexapac-ethyl formulation according to claim 1, wherein the suitable primary emulsifier is an ethoxylated tristyrylphenol.

3. The trinexapac-ethyl formulation according to claim 2, wherein the ethoxylated tristyrylphenol also acts as a surfactant.

4. The trinexapac-ethyl formulation according to claim 1, which further includes an additional emulsifier or surfactant that is a linear calcium dodecylbenzene sulphonate.

5. The trinexapac-ethyl formulation according to claim 1, that is an emulsifiable concentrate, micro-emulsion, oil dispersion, oil in water emulsion, oil miscible liquid, suspo-emulsion or a mixed formulation such as a capsule suspension and suspo-emulsion or capsule suspension and emulsion in water.

6. The trinexapac-ethyl formulation according to claim 1 that:
a. is adapted to form a stable emulsion when diluted at a concentration of at least 5 grams of active ingredient per litre of water; and/or
b. is adapted to form a microemulsion when diluted at a concentration of 1 gram of active ingredient per litre of water.

7. The trinexapac-ethyl formulation according to claim 1, which has a pH of 3.0 or greater upon dilution in water.

8. The trinexapac-ethyl formulation according to claim 1, wherein the concentration of trinexapac-ethyl is more than 600 g ai/L.

9. The formulation of claim 1 when used as a tank mix, in a co-formulation or in a sequence of applications.

10. The formulation of claim 9, when used in a tank mix or a co-formulation with a fertiliser and/or other plant nutritional preparation.

11. The formulation according to claim 1 that also contains a systemic acquired resistance compound.

12. The formulation according to claim 1 that also contains an adjuvant, surfactant, penetrant, spreader or wetter for use either in a tank mixture or as a co-formulant.

13. The formulation of claim 1, when used as a plant growth regulator/retardant, chemical ripener, alkaloid ratio modifier or harvest aid.

14. The formulation of claim 1, when applied to turfgrass to reduce vegetative growth and increase NDVI.

15. The formulation of claim 1, when applied to cereals such as wheat, barley, oats, triticale or rye to reduce vegetative growth, lodging and/or brackling and to increase NDVI.

16. The formulation of claim 1, when applied to rice to reduce vegetative growth and/or lodging.

17. The formulation of claim 1, when applied to poppies to modify alkaloid content.

18. The formulation of claim 1, when applied to sugarcane to increase commercial cane sugar content.

19. The formulation of claim 1, when applied as an emulsifiable concentrate in water volumes of 200 L/ha or less or when applied at an active ingredient rate greater than 100 g ai/ha, in water volumes of greater than 200 L/ha.

20. The formulation of claim 1, when applied as a micro-emulsion in sensitive areas such as turfgrass greens in water volumes of >200 up to 3000 L/ha.
